(19) United States
(12) Patent Application Publication
(10) Pub. No.: US 2006/0184413 A1
(43) Pub. Date: Aug. 17, 2006

(54) System and method to manage resources

(76) Inventors: Brian DelMonego, Chester Springs, PA (US); Betty Fink, Bear, DE (US); Gary Grzywacz, Harleysville, PA (US); James Pressler, West Chester, PA (US); Donald Taylor, Downingtown, PA (US); Arnold Teres, Broomall, PA (US)

Correspondence Address: Siemens Corporation;Intellectual Property Department, 170 Wood Avenue South, Iselin, NJ, 08830, US

(21) Appl. No.: 11/266,557

(22) Filed: Nov. 3, 2005

Related U.S. Application Data
(60) Provisional application No. 60/627,371, filed on Nov. 12, 2004.

(51) Int. Cl. G06F 15/02

(52) U.S. Cl. 705/9

(57) ABSTRACT

A system and method for management including steps of defining revenue associated with at least one procedure, monitoring revenue generated by performance of the at least one procedure throughout a plurality of personnel and dynamically assigning at least one of the plurality of personnel based on the monitored revenue. The system and method has use in a healthcare management scenario, for example.

This is a non-provisional application based on U.S. provisional application Ser. No. 60/627,371 to DelMonego et al., filed Nov. 12, 2004.

### FIELD OF THE INVENTION

This present invention relates to a computer-implemented resource management system and method, and in particular, to a system and method for managing and allocating the resources of a hospital or health care facility department in real time.

### BACKGROUND OF THE INVENTION

One of the tasks of a shift manager or resource manager within a factory (e.g., automobile manufacturing factory) is to increase the revenue and profit of the particular department to which the manager is assigned.

Radiology departments of hospitals and health care facilities typically include large staffs which must be effectively managed, and expensive imaging equipment to which access must also be effectively managed. Often times, radiology departments include managers whose responsibility it is to keep operations running smoothly with the highest revenue. In some cases, computer systems are utilized to assist the radiology department manager in allocating resources and maximizing revenue.

Existing computer systems employ simulations which allow estimation, simulation and display of costs and revenue for radiology departments. These systems are able to calculate a forecast for various workflow scenarios which may exist in the department at different time periods. These systems typically use estimated values as input data for the forecast or projection. These estimated values often comprise average values derived from, for example, workflow conditions from previous years.

However, these existing simulation systems are not connected with real, existing radiology centers (or other hospital departments), and are thus unable to access data in real time. Existing simulation systems are also not able to show current financial status, and are not able to adjust a current financial status by transferring staff, patients or procedures in real time, in order, for example, to improve the current revenue of the department.

Sometimes radiology department managers need a revenue report concerning different procedures occurring during a particular period of time using real-time information. In order to provide this report, existing simulation systems employ a substantial manual effort which is expensive and slow. Although the required data is often available within a Radiology Information System (RIS) database, workers have to search, copy and merge this data to provide a report, and thus the report is not available in real time.

Thus, there is presently a need for a system and method for managing the resources (e.g., staff, equipment, etc.) of one or more hospital or health care facility departments, and allocating such resources in real time to maximize revenue.

### SUMMARY OF THE INVENTION

An exemplary embodiment of the present invention comprises a radiology financial information processing system, including an acquisition processor for acquiring data identifying radiology procedures performed in a current time period and associated reimbursement revenue for individual procedures and historical data indicating previous radiology procedures performed in a previous corresponding time period and associated reimbursement revenue for said previous procedures, and a display processor for initiating generation of data representing a display image enabling visual comparison of reimbursement revenue in said current time period and previous corresponding time period to support identifying discrepancies.

Another exemplary embodiment of the present invention comprises a method for management including the steps of defining revenue associated with at least one procedure, monitoring revenue generated by performance of the at least one procedure throughout a plurality of personnel and dynamically assigning at least one of the plurality of personnel based on the monitored revenue.

### BRIEF DESCRIPTION OF THE DRAWINGS

FIG. 1 is a block diagram showing a computer system according to an exemplary embodiment of the present invention.

FIG. 2 is a block diagram showing a method according to an exemplary embodiment of the present invention.

### DETAILED DESCRIPTION

The present invention comprises, in one exemplary embodiment, a computer-implemented system and method to determine and display the revenue associated with medical procedures in real time so that medical resources (e.g., staff, equipment, etc.) can be dynamically assigned to maximize revenue and profit. The revenue may be defined and grouped as being associated with a particular hospital or health care facility, a particular hospital or health care facility department, particular health care equipment, particular procedure steps, particular user groups, or a particular clinician or clinicians. In one exemplary embodiment of the present invention, the system and method is used in conjunction with a hospital radiology department, and with a Radiology Information System (RIS) database.

Preferably, revenue is calculated in real-time in the present system and method, and is not estimated or simulated. The displayed revenue of a selected group (e.g., hospitals, departments, etc.) shows the actual (real-time) revenue situation of the selected group, and allows a user to see the revenue that is being generated as it is generated through the performance of procedures. Thus, a radiology manager (or other health care manager) can see where revenue is low (i.e., real-time screening), and, based on his or her conclusions, the manager is able to re-assign resources from one area to another area in order to get more procedures completed, which in turn produces more revenue.

Similarly the manager is able to manage areas where there are a low number of waiting procedure steps, and an excessive number of assigned staff. In this case, the manager removes staff from the low demand area, and provides additional different tasks in other areas.

Consider an exemplary radiology procedure (e.g., head Computed Tomography (CT) scan, etc.) as tracked within the RIS database. The procedure is known to generate a specific amount of revenue for the health care facility based on past experience and current costs (e.g., $500.00). By tracking the revenue associated with a head CT scan when it is incurred (or soon thereafter), the manager of the radiology department can know in real-time how much revenue is being generated by performance of the procedure, and by tracking multiple different procedures, can determine how much revenue is being generated by the radiology department as a whole. When assessing such revenue changes, a department manager can dynamically assign (or re-assign) personnel between areas of the department to maximize revenue. The department manager may communicate such requests to personnel via a printed work list, telephone call, e-mail, or other equivalent means.

In order to check if a particular staff person is able to perform a new task, the computer-implemented system and method can employ a skill profile that is compared with the profile needed for the selected job. However, in many cases the department manager is aware of the available skills and the needed skills for each task, and is able to assign a staff person to appropriate procedures without the need for computer-based skill matching.

Using the present computer-implemented system and method, a hospital or health care manager is thereby able to control workflow based on real-time revenue information. This allows a user to find the bottlenecks and improve the current revenue by shifting resources or procedures in real-time.

For example, the above-described system and method is able to show for each selected department (e.g., radiology) or procedure (e.g., head CT scans) the current revenue. The revenue is calculated based on real-time data from the selected procedure or department. If the radiology department currently shows a revenue of $4,200.00 at 12:00 Noon, and an average revenue for this department at this time of day is normally $23,200.00, the manager notes the discrepancy. The manager then investigates why the revenue is so low and finds out that three (3) staff members are out sick. The manager can now bring in other staff members, or move staff around from another section of the department.

The present computer-implemented system and method evaluates in real time what work is occurring within each area of a department (e.g., radiology department) and permits automatic shifting of human resources from one area to another to optimize revenue opportunities. For example, if the CT department has twenty (20) patients waiting to get scanned but only one CT technician working, and the Nuclear Medicine (Nuc Med) department has no patients waiting but has three (3) technicians working, then if one of those 3 Nuc Med technicians knows how to do CT scans, he or she can be moved over to CT immediately. Thus, it is clear that having the ability to dynamically assign personnel is key to maximizing revenue.

The present system and method includes: (1) the ability to control workflow based on real-time revenue from selected procedures or departments, (2) the ability to see the revenue bottleneck within the workflow (by examining displayed and compared values), (3) the ability to see the reasons that cause the revenue bottleneck (e.g., too many staff, not enough staff, not enough procedure numbers, etc.), and (4) the ability to know where more or less resources are needed in order to keep the revenue flowing (by examining a displayed overview).

The present system and method is preferably implemented on a computer, or network of computers as an executable application. The executable application displays on a computer screen the current revenue (or other profit-based parameter) assigned to a selected procedure or department. The calculation of current revenue (or other related parameters) is based on real-time data and reflects the current situation within the department (e.g., radiology). The executable application preferably also allows display of average revenue (or other profit-based parameter) assigned to a selected procedure or department. The average revenue calculation is used for comparison, to enable a user to find discrepancies from the norm. The average revenue (or other related parameters) may be calculated (based on prior time periods) or entered by a surveying user. The executable application preferably also displays parameters that identify a cause of a discrepancy between an expected average value and a real-time value (e.g., staff persons are out sick, etc.).

The executable application preferably displays revenue or another profit focused parameter assigned to selected medical procedures or a particular hospital or health care facility department. The calculation of these parameters is preferably based on real-time data that describes the current situation within the department. The executable application preferably also allows display of average revenue or another profit focused parameter assigned to selected procedures or a particular department. These parameters may be used for comparison to enable a user to find discrepancies, or variations normal operating conditions. These parameters may be calculated or entered by a surveying user. The executable application preferably also displays parameters that identify a cause of a discrepancy between expected average value and the real-time value of a profit focused parameter of selected procedures or a particular department.

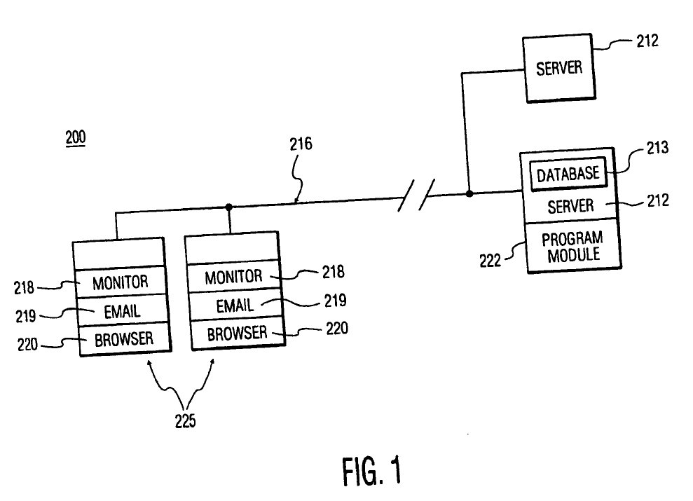

FIG. 1 shows a client-server computer system 200 according to an exemplary embodiment of the present invention which may be utilized to carry out a method according to an exemplary embodiment of the present invention. The computer system 200 includes a plurality of server computers 212 and a plurality of user computers 225 (clients). The server computers 212 and the user computers 225 may be connected by a network 216, such as for example, an Intranet or the Internet. The user computers 225 may be connected to the network 216 by a dial-up modem connection, a Local Area Network (LAN), a Wide Area Network (WAN), cable modem, digital subscriber line (DSL), or other equivalent connection means (whether wired or wireless).

Each user computer 225 preferably includes a video monitor 218 for displaying information. Additionally, each user computer 225 preferably includes an electronic mail (e-mail) program 219 (e.g., Microsoft Outlook®) and a browser program 220 (e.g. Microsoft Internet Explorer®, Netscape Navigator®, etc.), as is well known in the art. Each user computer may also include various other programs to facilitate communications (e.g., Instant Messenger™, NetMeeting™, etc.), as is well known in the art.

One or more of the server computers 212 preferably include a program module 222 (i.e., the executable application described above) which allows the user computers 225 to communicate with the server computers and each other over the network 216. The program module 222 may include program code, preferably written in Hypertext Mark-up Language (HTML), JAVA™ (Sun Microsystems, Inc.), Active Server Pages (ASP) and/or Extensible Markup Language (XML), which allows the user computers 225 to access the program module through browsers 220 (i.e., by entering a proper Uniform Resource Locator (URL) address). The exemplary program module 222 also preferably includes program code for facilitating a method of simulating leadership activity among the user computers 225, as explained in detail below.

At least one of the server computers 212 also includes a database 213 for storing information utilized by the program module 222 in order to carry out the method for determining and displaying revenue in real-time. For example, values for the revenue associated with particular procedures may be stored in the database. Although the database 213 is shown as being internal to the server in FIG. 1, those of ordinary skill in the art will realize that the database 213 may alternatively comprise an external database. Additionally, although database 213 is shown as a single database in FIG. 1, those of ordinary skill in the art will realize that the present computer system may include one or more databases coupled to the network 216.

In order to perform some of the functions of the method for determining and displaying revenue in real-time, at least one of the user computers 225 or server computers 212 may include an acquisition processor for acquiring data identifying medical procedures performed in a specific time period (e.g., a current time period), an associated reimbursement revenue value for individual procedures, and historical data indicating previous medical procedures performed in a previous corresponding time period (e.g., a previous time period) and associated reimbursement revenue values for said previous procedures. This associated reimbursement revenue for individual medical procedures may comprises a measure or calculation of received revenue and/or expected revenue. The ‘current’ and ‘previous’ time periods referenced above may comprise time periods such as a fraction of a second, a second, a minute, an hour, a day, a week, a month and a year.

The acquisition processor may also acquire and process data identifying staff associated with performing medical procedures in certain time periods and utilize this data to display a display image indicating the identified staff associated with performing such procedures in a specific time period. This display image may also be used to compare identified staff associated with performing medical procedures in current and previous time periods, thus enabling visual comparison of staff numbers and procedure workload.

At least one of the user computers 225 or server computers 212 may also include a display processor for initiating generation of data representing a display image, enabling visual comparison of reimbursement revenue in said current time period and previous corresponding time period to support identifying discrepancies.

The acquisition processor may be utilized to determine an accumulated reimbursement revenue value for medical procedures in current and previous time periods for display as an image on one or more of the monitors 218 of the user computers 225. The accumulated reimbursement revenue value may comprise an average value, a mean value, or an expected value (based on past performance).

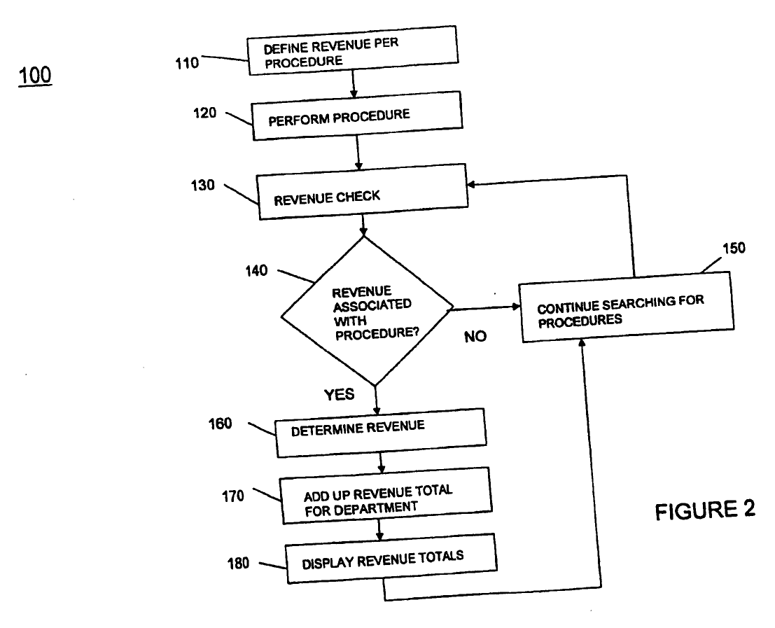

FIG. 2 is a block flow diagram showing a method for determining and displaying revenue in real-time which includes a first step 110 of a user entering revenue data for at least one medical procedure into one of the user computers 225 connected to the network 216. The revenue data may be generated by defining rules and input parameters for the data, performing one or more calculations, and displaying the parameter. Alternativley, a default value for the revenue data may be utilized. Once entered, the revenue data is preferably transmitted over the network 216 to one or more of the server computers 212 where it is stored in one or more databases 213. Alternatively, in a non-network environment, the revenue data may be stored in a database locally at the user computer 225. After the revenue data is entered, it can be accessed each time the particular procedure is performed. For example, if the revenue data relates to a head CT scan procedure, that data will be referenced or accessed each time a head CT scan is performed.

At step 120, various procedures are performed at the hospital or health care facility, some which generate revenue, and some which do not. After a specified time period has elapsed, the system checks for new revenue at step 130, by checking all the procedures performed in the time period. In other words, the revenue generated by specific medical procedures is monitored over a particular time period. The specified time period may comprise a fraction of a second, seconds, minutes, a number of hours, a day, a week, a month, or a year, for example. In order for the system and method to operate closer to ‘real time’, a time period of minutes, seconds or fractions of seconds may be selected. For each procedure, the system checks to see if there is revenue associated with the procedure at step 140. If there is associated revenue, the revenue is determined at step 160. Thus, a total revenue value for specific procedure performed in a specific time period is determined. This total revenue value may be stored for future reference and comparison to other total revenue values generated in other time periods. By keeping track of this historical total revenue data, a manager of a particular department performing such procedures can easily determine if revenue is up or down for a particular time period, and take steps to rectify the inadequacy if need be. If there is no associated revenue, the method continues to search for procedures at step 150. After the expiration of another time period (e.g., the following day, if the time period is set to one day), the revenue will be checked again at step 140, and the process proceeds as above from there.

At step 170, the revenue determined in the specific time period is added up to generate a total revenue number for the time period. This total revenue may be displayed to the user at step 180. Upon examining this total revenue, and comparing it to historical revenue totals for similar time periods, the user can determine if the department is operating at a loss or gain. For example, if the total revenue for a particular day in June was determined to be $50,000.00, and in prior years the health care department was generating $75,000.00 per day in the month of June, the manager would determine that the department was operating at a loss, and would take steps to determine and remedy the problem, such as hiring additional personnel, firing personnel, and/or dynamically assigning or re-assigning personnel.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters.

A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

As used herein the term “code segment” means a portion of a set of machine-readable instructions, such as a portion of a computer program, or a portion of computer program code.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. A radiology financial information processing system, comprising:
an acquisition processor for acquiring,
data identifying radiology procedures performed in a current time period and associated reimbursement revenue for individual procedures; and
historical data indicating previous radiology procedures performed in a previous corresponding time period and associated reimbursement revenue for said previous procedures; and
a display processor for initiating generation of data representing a display image enabling visual comparison of reimbursement revenue in said current time period and previous corresponding time period to support identifying discrepancies.

2. A system according to claim 1, wherein said acquisition processor determines an accumulated reimbursement revenue for said procedures in said current and previous time periods for display in said display image.

3. A system according to claim 2, wherein said accumulated reimbursement revenue comprises at least one selected from the group consisting of: an average value, a mean value and an expected value.

4. A system according to claim 1, wherein said associated reimbursement revenue for individual procedures in said current time period comprises at least one selected from the group consisting of: received revenue and expected revenue.

5. A system according to claim 1, wherein said acquisition processor acquires data identifying staff associated with performing said procedures in said current time period and said display image presents data indicating said identified staff associated with performing said procedures in said current time period.

6. A system according to claim 5, wherein said display image presents data indicating said identified staff associated with performing said procedures in said previous time period enabling visual comparison of staff numbers and procedure workload.

7. A system according to claim 1, wherein said current time period comprises a period starting at the present time and covering a duration of at least one selected from the group consisting of: a fraction of a second, a second, a minute, an hour, a day, a week, a month and a year.

8. A system according to claim 1, wherein said current time period comprises at least one selected from the group consisting of: a fraction of a second, a second, a minute, an hour, a day, a week, a month and a year.

9. A method for management comprising the steps of:
defining revenue associated with at least one procedure;
monitoring revenue generated by performance of the at least one procedure throughout a plurality of personnel; and,
dynamically assigning at least one of the plurality of personnel based on the monitored revenue.

10. The method of claim 9, wherein the revenue is monitored in real time.

11. A computer system comprising: at least one server computer; and, at least one user computer coupled to the at least one server through a network, wherein the at least one server computer includes at least one program stored therein, said program performing the steps of:
defining revenue associated with at least one procedure;
monitoring revenue generated by performance of the at least one procedure throughout a plurality of personnel; and,
displaying total revenue generated by the performance of procedures, to permit the dynamic assignment of at least one of the plurality of personnel based on the total revenue.

12. The computer system of claim 11, wherein the total revenue is displayed in real time.

13. A computer readable medium having embodied thereon a computer program for processing by a machine, the computer program comprising:
a first code segment for defining revenue associated with at least one procedure;
a second code segment for monitoring revenue generated by performance of the at least one procedure throughout a plurality of personnel; and
a third code segment for displaying total revenue generated by the performance of procedures, to permit the dynamic assignment of at least one of the plurality of personnel based on the total revenue.

14. The computer readable medium of claim 13, wherein the total revenue is displayed in real time.

15. A computer data signal embodied in a carrier wave comprising:
a first code segment for defining revenue associated with at least one procedure;
a second code segment for monitoring revenue generated by performance of the at least one procedure throughout a plurality of personnel; and,
a third code segment for displaying total revenue generated by the performance of procedures, to permit the dynamic assignment of at least one of the plurality of personnel based on the total revenue.

16. The computer data signal of claim 15, wherein the total revenue is displayed in real time.
